(19) United States
(12) Patent Application Publication
(10) Pub. No.: US 2016/0005004 A1
(43) Pub. Date: Jan. 7, 2016

(54) SYSTEM, METHOD, AND MEDIUM FOR SCHEDULING CONSUMER SERVICES AND PRODUCT ARRANGEMENTS

(71) Applicant: Carrie Trabue, Austin, TX (US)

(72) Inventor: Carrie Trabue, Austin, TX (US)

(21) Appl. No.: 14/789,215

(22) Filed: Jul. 1, 2015

Related U.S. Application Data
(60) Provisional application No. 62/019,683, filed on Jul. 1, 2014.

(51) Int. Cl. G06Q 10/10; G06Q 30/06; G06Q 50/00; H04W 4/02

(52) U.S. Cl. CPC G06Q 10/1095; H04W 4/023; G06Q 30/0623; G06Q 50/01

(57) ABSTRACT

A system and method for finding relevant businesses and scheduling appointments based upon proximity to a user or customer. A user searches for appointment-oriented businesses and receives feedback through an augmented reality interface that presents scheduling options, which may be confirmed through the interface.

### CROSS-REFERENCE TO RELATED APPLICATIONS

This specification and application is based upon a U.S. Provisional application, having Application No. 62/019,683, which is hereby incorporated by reference in its entirety.

### BACKGROUND

Varying embodiments of the invention function to aid a consumer or computer end-user to identify and locate desired products and services and make temporal arrangements associated with desired products and services. For example, a tourist walking through New York City may desire a massage but have little notion regarding where to purchase massage services and, more importantly, how to quickly and conveniently find and book an available time with a reputable massage therapist that is appropriately located. Similarly, a consumer may want to purchase home improvement goods (e.g., lighting, plumbing, and/or premium appliances) from a showroom that requires appointments in order to access sales help, but the proximity of a showroom and availability of the desired sales assistance is not conveniently available.

### SUMMARY

Embodiments of the invention involve a cross platform application (i.e., it may operate on iOS and Android mobile devices, desktop computers, Windows and Mac computers, and many other platforms) that cooperates (e.g., over the Internet) with various scheduling software platforms used by retail service businesses. Retail businesses may include spas, salons, auto-repair businesses, restaurants, hotels, electricians, plumbers, dentists, etc. The application may exploit GPS information so a person desiring a service can locate nearby service providers who have available appointments at the user's requested date and time. The appointment times displayed may be pulled/pushed in real time from the various scheduling software platforms used by the retail service businesses utilizing the application. The application may also incorporate other information such as user ratings and may employ any type of user interface, including lists (with distance), map view, and augmented reality view.

### BRIEF DESCRIPTION OF THE DRAWINGS

FIG. 1 is an illustrative hardware configuration

FIG. 2 is an illustrative network arrangement.

FIG. 3 is an illustrative software arrangement

FIG. 4 is an illustrative example of a client component and a service provider component.

FIG. 5 is an illustrative example of a client component, a service provider component, and other information providers.

FIG. 6 is an illustrative example of a client component, multiple service provider components, and other information providers.

FIG. 7 is an illustrative example of multiple client components, multiple service provider components, and other information providers.

FIG. 8 is an illustrative example of multiple client components, multiple service provider components, a client services component, and other information providers.

FIG. 9 is an illustrative example of multiple client components, multiple service provider components, a service provider server component, a client services component, and other information providers.

FIG. 10 is another illustrative example of multiple client components, multiple service provider components, a service provider server component, a client services component, and other information providers.

FIG. 11 is an illustrative process flow diagram.

FIG. 12 is an illustrative user interface.

FIG. 13 is an illustrative user interface.

FIG. 14 is an illustrative user interface.

FIG. 15 is an illustrative user interface.

FIG. 16 is an illustrative user interface.

FIG. 17 is an illustrative user interface.

FIG. 18 is an illustrative user interface.

FIG. 19 is an illustrative user interface.

FIG. 20 is an illustrative user interface.

FIG. 21 is an illustrative user interface.

### DETAILED DESCRIPTION

Hardware and Software Background

The embodiments described herein may have implication and use in all types of single and multi-processor computers. Most of the discussion herein focuses on a common computing configuration having a CPU containing one or more microprocessors cores. The discussion is only for illustration and is not intended to confine or limit the invention. The inventor intends that other systems having other known or common hardware or software configurations may be used in conjunction with the inventive concepts discussed here.

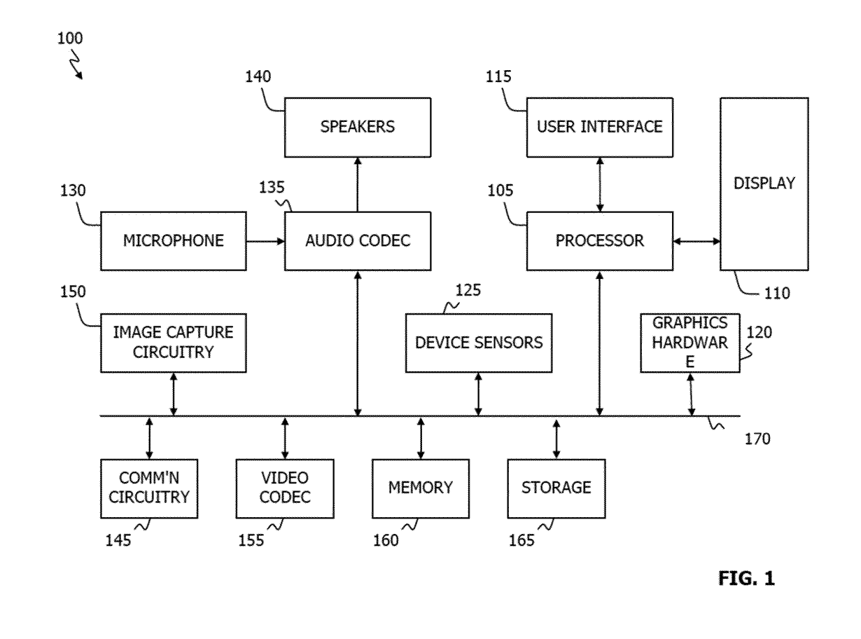

Referring to FIG. 1, a simplified functional block diagram of illustrative electronic device 100 is shown according to one embodiment. Electronic device 100 could be, for example, a smartphone or other mobile computer, a desktop, or stationary computer such as a server. As shown, electronic device 100 may include processor 105, display 110, user interface 115, graphics hardware 120, device sensors 125 (e.g., GPS, proximity sensor/ambient light sensor, accelerometer, and/or gyroscope), microphone 130, audio codec(s) 135, speaker(s) 140, communications circuitry 145, image capture circuitry 150, video codec(s) 155, memory 160, storage 165, and communications bus 170.

Processor 105 may execute instructions necessary to carry out or control the operation of many functions performed by device 100 (e.g., running client applications, server applications, and databases). In general, many of the functions performed herein may be based upon a processor acting upon software embodying a function to convert the general purpose computer into a special purpose computer. Processor 105 may, for instance, drive display 110 and receive user input from user interface 115. User interface 115 can take a variety of forms, such as a button, keypad, keyboard, display screen, and/or a touch screen. Processor 105 may be a system-on-chip, such as those found in mobile devices, and may include a dedicated graphics processing unit (GPU). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or assisting processor 105 to process graphics information.

Output from image capture circuitry 150 may be processed, at least in part, by video codec(s) 155 and/or processor 105 and/or graphics hardware 120 and/or a dedicated image processing unit incorporated within image capture circuitry 150. Images so captured may be stored in memory 160 and/or storage 165. Memory 160 may include one or more different types of media used by processor 105, graphics hardware 120, and image capture circuitry 150 to perform device functions. For example, memory 160 may include memory cache, read-only memory (ROM), and/or random access memory (RAM). Storage 165 may store media (e.g., audio, image, and video files), computer program instructions or software (including database applications), preference information, device profile information, and any other suitable data. Storage 165 may include one more non-transitory storage media including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 160 and storage 165 may be used to retain computer program instructions or code organized into one or more modules and written in any desired computer programming language. When executed by, for example, processor 105, such computer program code may implement one or more of the method steps or functions described herein thereby transforming the host device.

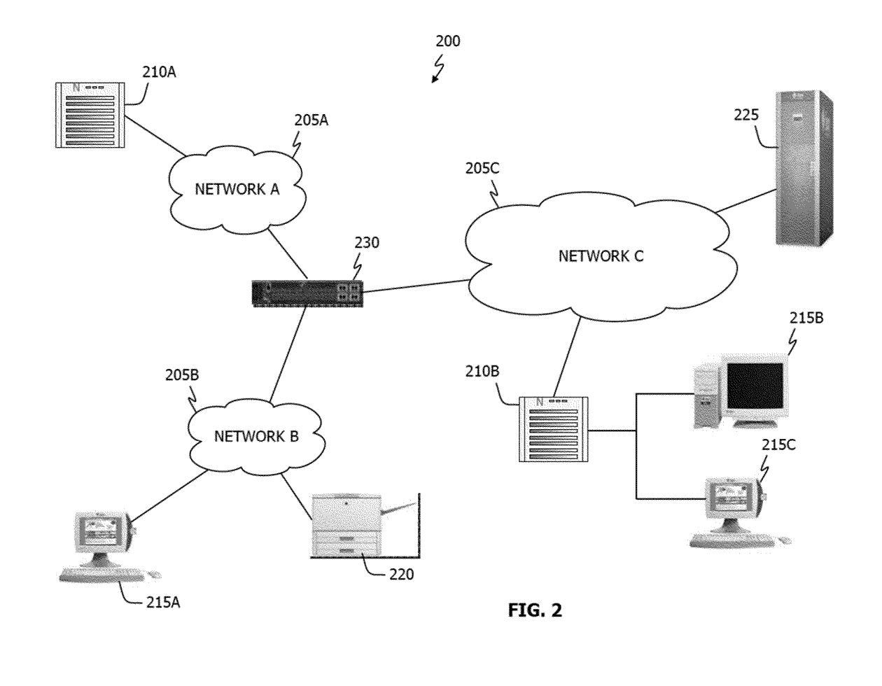

Referring now to FIG. 2, illustrative network architecture 200, within which the disclosed techniques may be implemented, may include a plurality of networks 205, (i.e., 205A, 205B, and 205C), each of which may take any form including, but not limited to, a local area network (LAN) or a wide area network (WAN), such as the Internet. Further, networks 205 may use any desired technology (wired, wireless, or a combination thereof) and protocol (e.g., transmission control protocol, TCP). Coupled to networks 205 are data server computers 210 (i.e., 210A and 210B) that are capable of operating server applications such as databases and also capable of communicating over networks 205. Also coupled to networks 205, and/or data server computers 210, are end-user computers 215 (i.e., 215A, 215B, and 215C), which may take the form of any computer, smart phone, entertainment device, communications device, or intelligent machine.

To facilitate communication between different network devices (e.g., data servers 210, end-user computers 215, network printers 220, and storage systems 225), at least one gateway or router 230 may be optionally coupled therebetween. Furthermore, in order to facilitate such communication, each device employing the network may comprise a network adapter. For example, if an Ethernet network is desired for communication, each participating device may have an Ethernet adapter or embedded Ethernet capable ICs. Further, the devices may carry network adapters for any network in which they will participate (e.g., WiFi, Bluetooth, etc.).

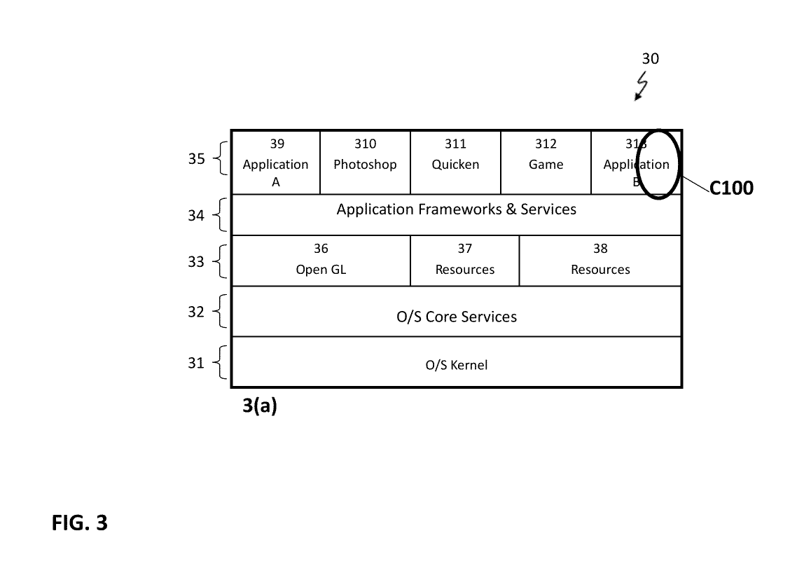

As noted above, embodiments of the inventions disclosed herein may include software. As such, a description of common computing software architecture 30 is disclosed as expressed in layer diagrams of FIG. 3. Like the hardware examples, the software architecture 30 discussed here is not intended to be exclusive in any way, but rather illustrative. This is especially true for layer-type diagrams, which software developers tend to express in somewhat differing ways. In this case, the description begins with layers starting with the O/S kernel 31, so lower level software and firmware have been omitted. The notation employed here is generally intended to imply that software elements shown in a layer use resources from the layers below and provide services to the layers above. However, in practice, all components of a particular software element may not behave entirely in this manner.

Referring to FIG. 3, layer 31 is the O/S kernel, which provides core O/S functions in a highly protected environment. Above the O/S kernel is layer 32 O/S core services, which extends functional services to the layers above such as disk and communications access. Layer 33 is inserted to show the general relative positioning of the Open GL library 36 and similar resources 37 and 38. Layer 34 is an amalgamation of functions typically expressed as multiple layers: applications frameworks and application services. For purposes of this disclosure, these layers may provide high-level and often functional support for application programs that reside in the highest layer, shown here as item 35. Item C100 is intended to show the general relative positioning of the client-side software embodied by the client component for many embodiments of the invention. While the ingenuity of any particular software developer might place the functions of the software described at any place in the software stack, the client-side software hereinafter described is generally envisioned as user facing (e.g., in a user application) and/or as a resource for user-facing applications to employ functionality related to collection of crowd source information or display of enhanced video features as discussed below. On the server side, the inventions described herein may be implemented in varying embodiments including server application level software, database software, and both frameworks and resource modules.

No limitation is intended by these hardware and software descriptions, and the varying embodiments of the inventions herein may include all types of computing devices such as Macs, PCs, PDAs, phones, tablets, wearable computers (e.g., watches and Google GLASS™), servers or even embedded systems.

Functionally, embodiments of the invention may aid consumers or end-users in search of products and services by providing an interface to schedule appointments with geographically-convenient businesses and by providing information about the businesses, including: names of the businesses; professional ratings and reviews; ratings and reviews; descriptions (including photos and videos) of available products and services; distance to the businesses, including directions and estimated time to travel to the business; descriptions of the physical facility, including photos and videos; identifying and descriptive information (including photos and video) of management, ownership, and service professionals/technicians; neighborhood information describing the surrounding geographic community, such as crime statistics and demographics; and weather information pertaining to the location of the business at the time of a user's request or at the time of a requested appointment.

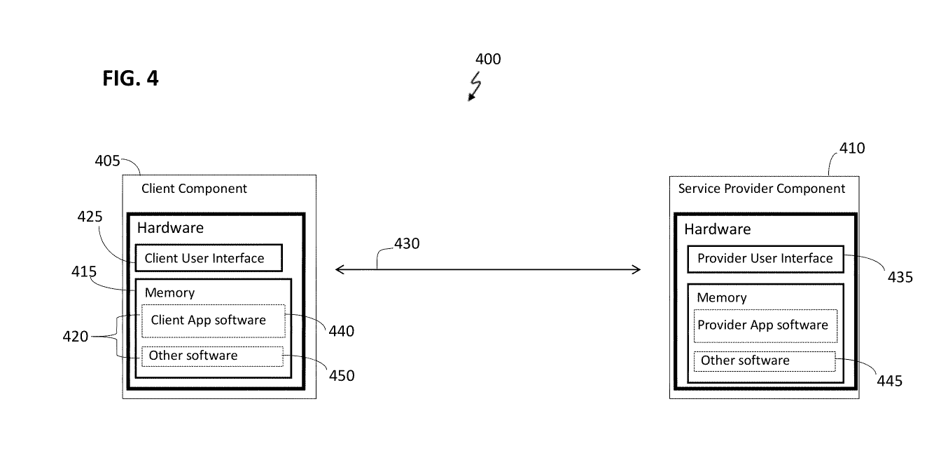

Generally referring to FIG. 4, some embodiments of the invention contemplate two structural or functional components 400 to provide the interface and information described: a client component 405 and one or more product/service provider component(s) 410 (hereafter “service provider component(s)”). The client component 405 may be embodied in a computing device such as a smart phone, smart watch, Google GLASS™, or any capable computing device. The client component 405 may use software 420, stored in a memory 415, such as a cross-platform client application 440, that may provide a client user interface 425 and may cooperate over a network 430 (such as the Internet) with one or more service provider component(s) 410. Each service provider component 410 may supply information and a scheduling interface 435 for one or more participating product/service businesses (e.g., a salon, auto repair business, etc.). The client component 405 may communicate with the service provider component(s) 410 to access information about the provider and/or to perform scheduling. The service provider component(s) 410 may be embodied in a computer as described above and may provide its own user interface 435 and functionality. In some embodiments, the service provider component(s) 410 may include legacy software 445 designed for the business of the service provider(s). There are a variety of business management, calendar, and scheduling software programs that may be natively accessed by the client application 440 or other software 450 on the client component 405 (e.g., DEMANDFORCE®, SPABOOKER®, MINDBODY® Online, GOOGLE CALENDAR™, etc.). For further illustration: with respect to the hotel industry, the client application 440 may interface over a network 430 with various hotel management software 445 such as DASHBELL®, GUESTPOINT™, WEBREZPRO™ or Frontdesk Anywhere. With respect to salons, legacy software 445 may include VAGARO®, SALONBOOKER®, Insight, SALON IRIS®, Rosy, STYLESEAT®, DEMANDFORCE®, Shortcuts, SCHEDULICITY®, MINDBODY®, or SPAFINDER®. With respect to restaurants, legacy software 445 may include OPENTABLE™, YELP®(Seat Me), TRIPADVISOR®, GOOGLE®, CITY EATS®, Eveve, or REZBOOK®. With respect to other service businesses, legacy software 445 may include Apps, Agenday, OUTLOOK®, GOOGLE CALENDAR™, iOS 7 Calendar, Sunrise Calendar, FANTASTICAL®, Agenda Calendar, TEMPO®, GoCal, SaiSuke, CalPad, FullSlate, CUSTOMER APPOINTMENT MANAGER™ 7.0, BOOKFRESH®, APPOINTY®, Acuity Scheduling, Appointment Quest, APPOINTMENT-PLUS®, Gen Book, Snap Appointments, Schedule Once, Setster, hitAppoint, Vcita, Setmore, DEMANDFORCE®, BOOKER™ SCHEDULICITY®. In some embodiments, the client application 440 and/or client component 405 may be adapted to communicate with each legacy provider application 445 to retrieve information and make reservations or appointments. In some other embodiments, the legacy software 445 may require updating in order to natively interface with the client application 440 and/or client components 405. In yet other embodiments, agent software may run alongside the legacy software 445 to provide for interface with the client application 440 and/or client component 405. In still other embodiments, plugins may be provided for the client application 440 in order to facilitate native communication with the legacy management (e.g., service provider application software) 445. Of course, the service provider component 410 may include one or more server computers and/or databases.

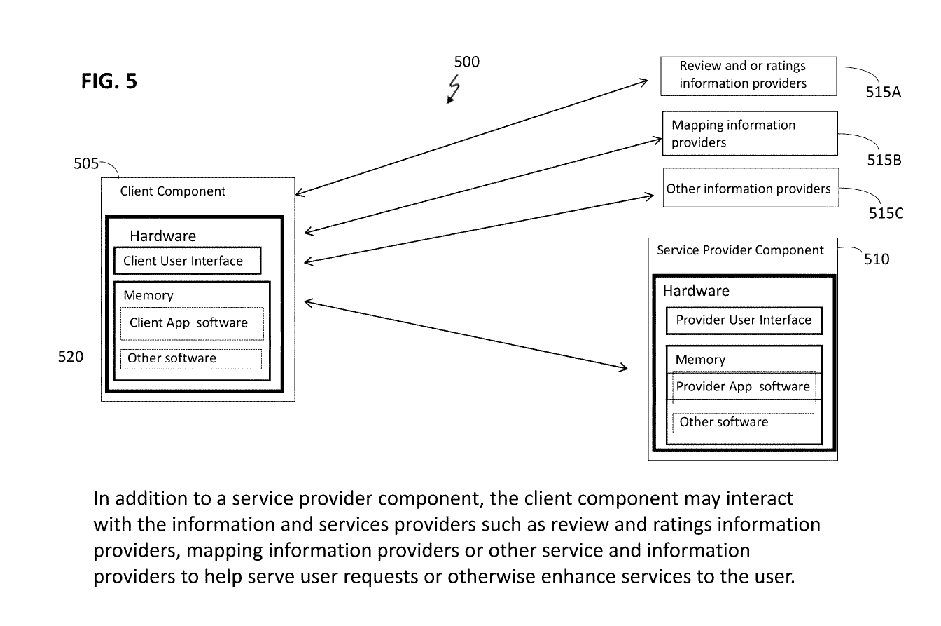

Generally referring to FIG. 5, in addition to interacting with a service provider component 510, the client application 520 and/or client component 505 may interact with third party information and service providers 515 (e.g., 515A, 515B, and 515C) to obtain information and services that are not available through the service provider component 510. For example, the client application 520 and/or client component 505 may access third party information for review and ratings information 515A regarding service and product providers. Other information and services potentially available through third party services may include: mapping information 515B, for example, to display locations of end-users (based on GPS data from the client component) and service providers or to provide travel directions; financial information or services such as credit checks or deposit charges associated with an appointment reservation; or other service and information providers 515C to help serve user requests or otherwise enhance services to the user. In addition, as an alternative to accessing some third party services, the client application 520 may be paired with a network accessible server that provides the information and/or services as part of the same family of products.

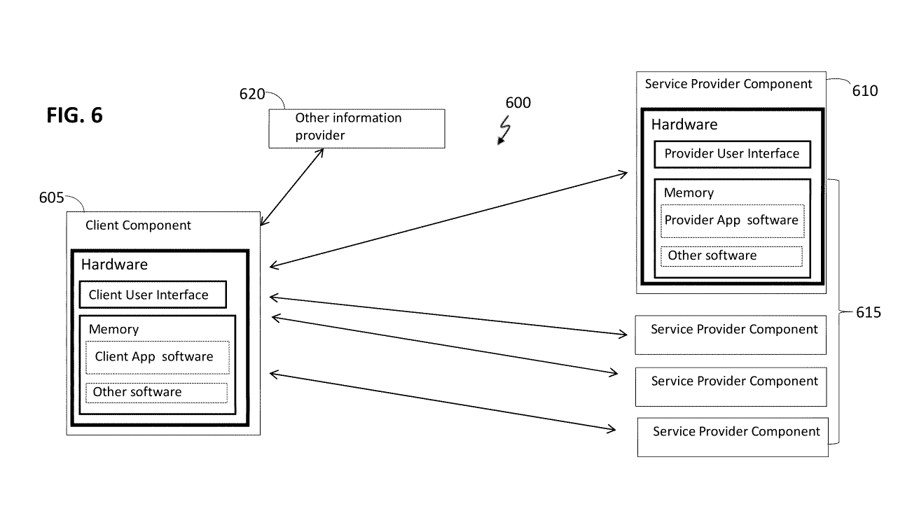

Generally referring to FIG. 6, as implied above, embodiments of the invention contemplate many service providers—up to millions—each potentially represented by its own service provider component 610. In particular, a service provider component 610 may be used for each service provider, as described below, or for a group of related service providers. In these embodiments, each client component 605 may independently interact with many or all of the service provider components 610 (or 615).

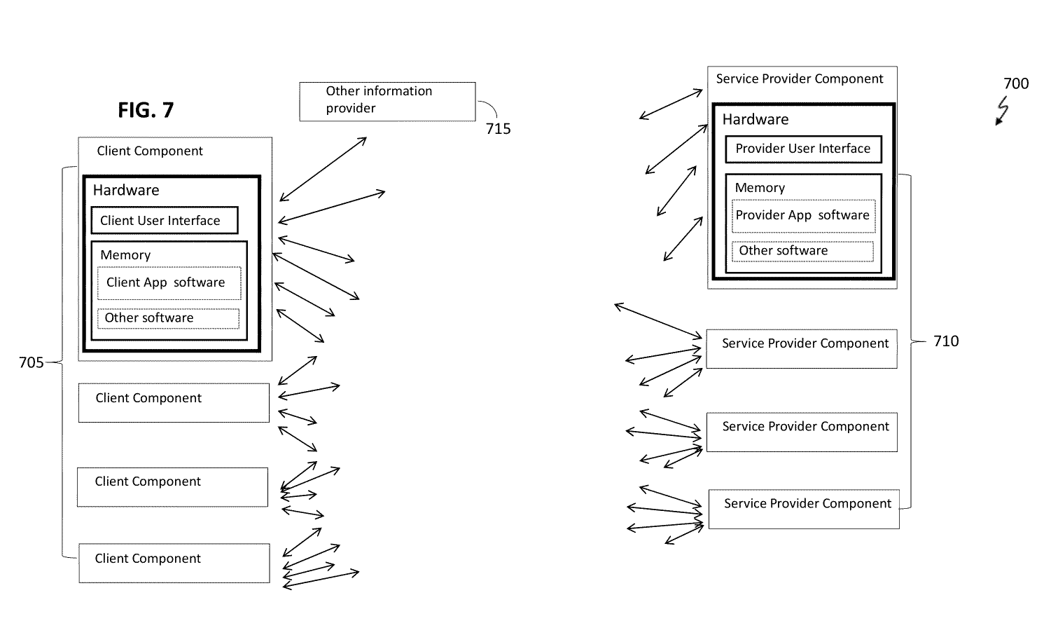

Generally referring to FIG. 7, some embodiments of the invention also contemplate potentially up to many millions of client components 705 (one or more per person). In such embodiments, all of the client components 705 may independently interact with all of the service provider components 710 to perform scheduling and to obtain information for an end user.

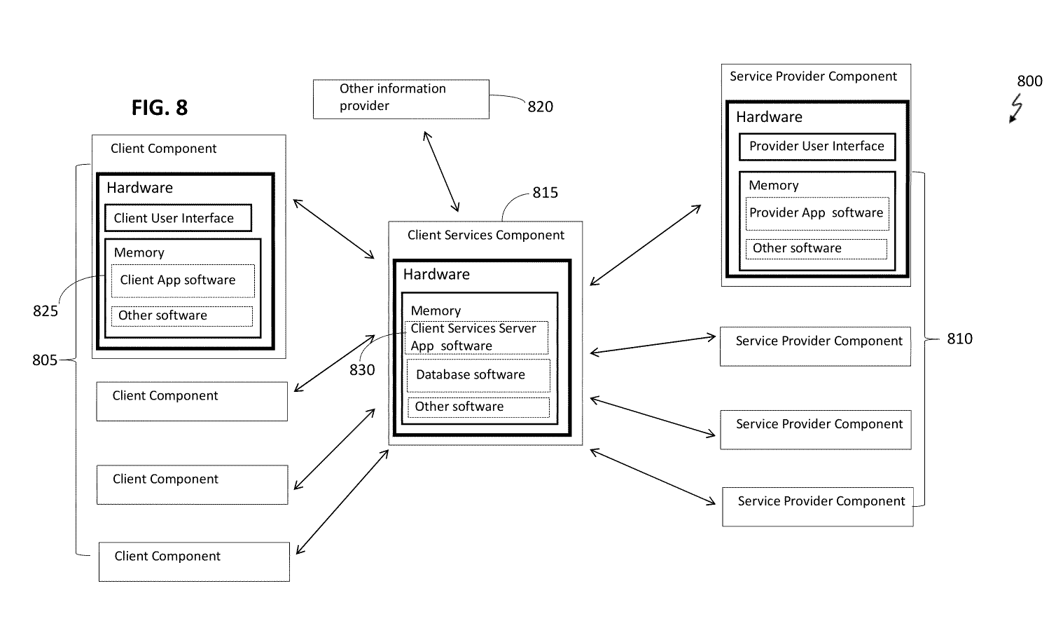

Generally referring to FIG. 8, in some embodiments the client components 805 can communicate with service provider components 810 through one or more servers represented as a client services component 815. The client services components 815 may aggregate information and functions of the other components. For example, a client services component 815 may aggregate information regarding service providers 820 so that the client component 805 and/or application 825 may acquire information regarding many or all service providers from a single source 815. By employing this architecture, the client services component 815 may hold responsibility for: individually communicating with service provider components 810; retaining information about each service provider, optionally in a database; keeping service provider information current; allowing or providing for registration of service providers so that new service providers may be added to the system; communicating with third party information providers 820 such as ratings, reviews and financial services; aligning information from third parties with the appropriate service providers, optionally by using a database; maintaining the service's own value-added features such as ratings, reviews, credit card processing, and even feedback to businesses regarding customer/end user trustworthiness (keeping their appointments or paying their bills).

Depending upon the embodiment, the client services component 815 may facilitate scheduling information to the client application 825 in any number of ways. In one embodiment, the client services application 830 may aggregate information concerning the identity of businesses that satisfy substantially static criteria, such as the service provider's geographic location, the category or nature of the service or products sold (e.g., cuisine of a restaurant), details of the service or product sold (e.g., the menu of a restaurant, the ambiences available, etc.). While no criteria is entirely static (e.g., businesses open, close, move, change menus, etc.), these type of criteria may be considered essentially static because they only require updating on time periods larger than a day or week. Also, in some embodiments, non-static information, such as scheduling information may not be aggregated on the client services component 815. In these embodiments, after a group of service providers are identified using the static information, the service provider component 810 for each identified service provider may be queried to obtain the most current schedule information. In some embodiments, the static information for any particular service provider may be updated or confirmed at the same time that the scheduling query is made. The task of querying the identified service providers may be performed by the client services component 815 or delegated to the client component 805 after a list of identified service providers is determined and conveyed. In addition, an identified list of service providers may include service providers that do not meet all the requested criteria. For example, if all criteria cannot be met or if near-miss alternatives may be offered, a broader set of service providers may be queried.

Still further embodiments of the invention may call for the client services component 815 to aggregate and hold all information by updating static and non-static information as frequently as appropriate. Yet other embodiments may call for the client services component 815 to hold only enough information to satisfy one or two criteria chosen from the following list: geographic location, nature of business, hours of operation, class of service—e.g., hotel stars, cuisine for restaurants.

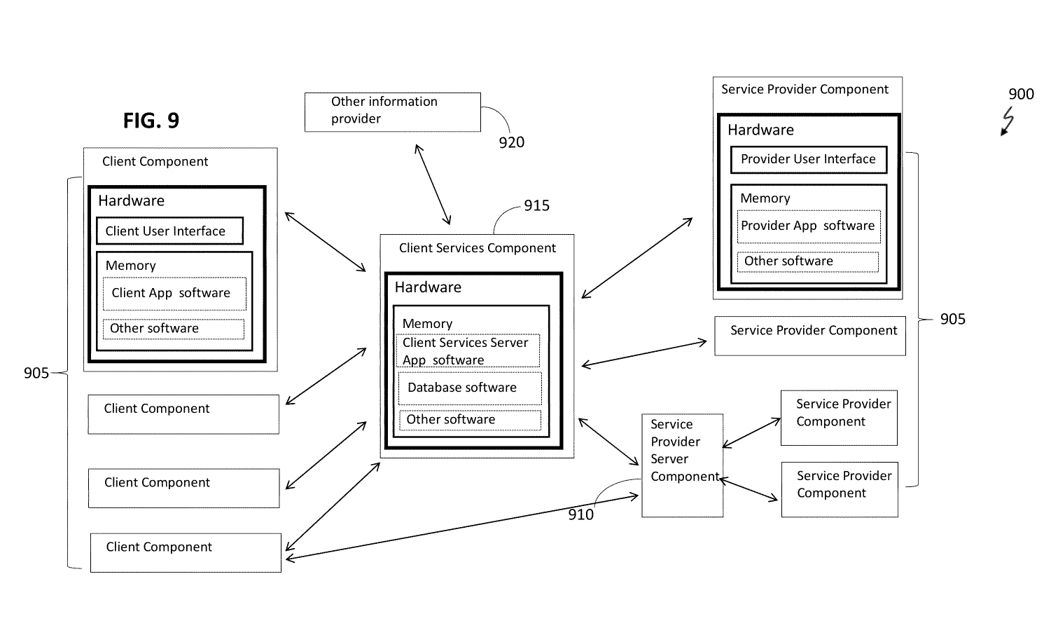

Referring generally to FIG. 9, in some embodiments, related service provider components 905 may use a service provider server component 910 to interact with a client services component 915 or potentially a client component 905. For example, since MASSAGE ENVY™ Spas are related through their own arrangements, all desirable MASSAGE ENVY™ store information and scheduling functionality may be available through a MASSAGE ENVY™ server, potentially running management software for all or a group of MASSAGE ENVY™ spas. In these cases, the client services component 915 or the client components 905 may access necessary or desirable information and functions through the MASSAGE ENVY™ servers instead of through individual contact with each spa. Similarly, often certain genres of businesses have scheduling or information services aggregated by third parties (e.g., OPENTABLE™ for restaurants, TRIPADVISOR® for hotels and travel services, etc.). In some embodiments, the third parties may be accessed through their servers 910 in lieu of direct contact with each service provider 905.

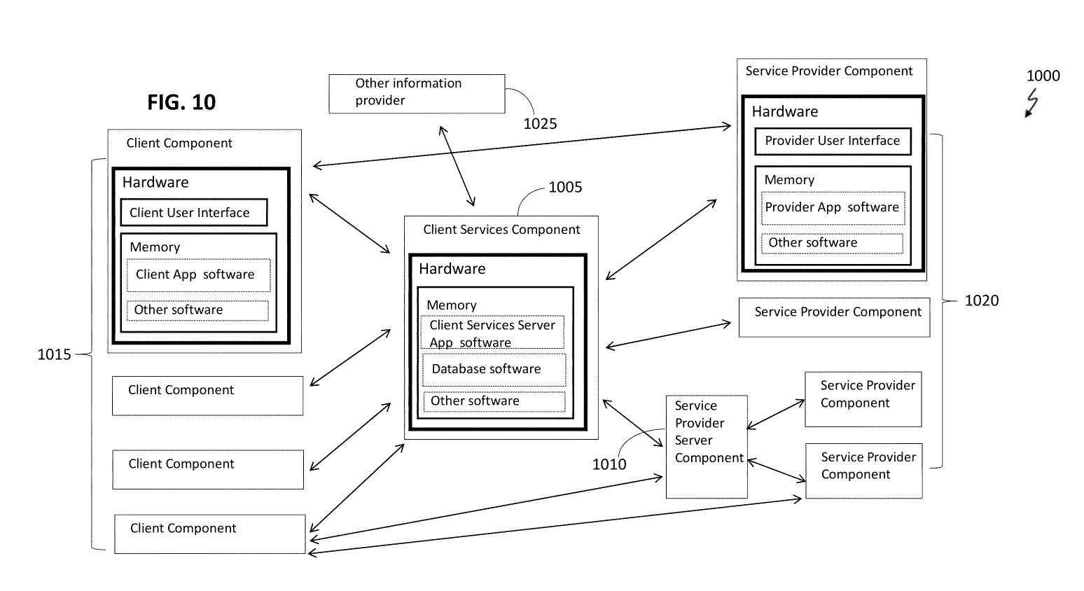

Generally with reference to FIG. 10, even though embodiments may employ one or more client services components 1005 or service provider server components 1010, client components 1015 may still interact directly with service provider components 1020 for some portion of information or interaction. For example, information may be retrieved from the client services component 1005, while scheduling may be performed with the service provider component 1020 directly.

Operational Example

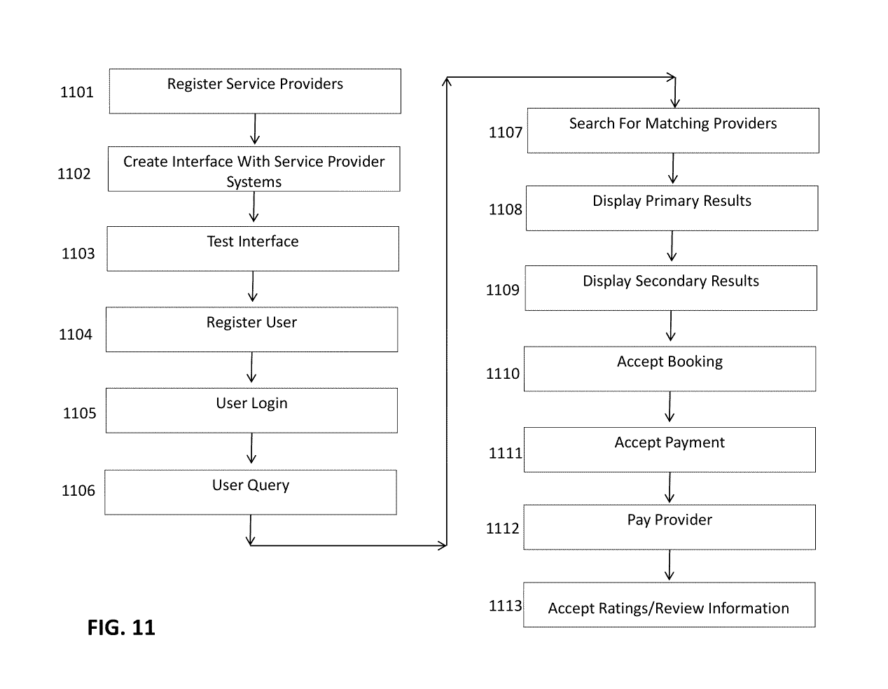

The following operational example is provided for illustration and is not intended to be limiting in any respect. The example is recited as a sequence of steps or acts, however, virtually all of the steps are optional and no order of the steps or acts is necessarily required. Referring to FIG. 11, at 1101 service providers may be registered with the inventive system. As discussed below, the service providers may register in any known way using the tools and interfaces discussed herein or otherwise. Referring to 1102, after a service provider's software program interface information is collected, a connection with the service provider's software may be created. In some embodiments, the connection may be automatically created by software. In other embodiments, custom programming or the use of plug-ins, agent software or the like may be necessary. Once a connection has been created, at 1103 the interface may be tested. In one embodiment, all of the functions of the interface may be exercised by a series of mock transactions. The results of the mock transactions may be evaluated to determine if the interface is operating as desired.

The inventive system operates, in part, for the benefit of end-user customers that desire services from the registered service providers. At 1104, these end users (e.g., operators of client components) may also register with the system using an interface provided by, for example, the client application software or by a web interface. End user registration information may include identifying information such as name and address, financial payment information, and a series of personal preferences related to the types of businesses embodied in the current or predicted future service providers. In some embodiments, the inventive system may provide for registration in cooperation with social media services and other Internet services such as FACEBOOK®, TWITTER®, PAYPAL®, LINKEDIN®, etc. When an end user employs a cooperative service provider to supply account information for registration, the inventive system may acquire preference and other information from the cooperative service. At 1105, a registered user may log onto the system through the client application or a web interface. Upon or after logon, the user may be presented with interfaces for inviting a query. The interfaces may take any form available or as illustratively discussed above and may include intelligent voice recognition.

At 1106 the user may provide a query or a question to the system using the provided interface. The query may present a variety of criteria that define the service or product experience desired by the user. For example, the criteria may be a type of business (e.g., salon or restaurant), a type of service (e.g., massage or dinner), a requested time frame, or a specific criterion such as “hot stones” for a massage or “Chinese” for a cuisine. The user input criteria may also include a location proximity request or requirement. In some embodiments, even if the user has not imposed a location request or requirement, the system may imply one, such as the GPS location of the client component, the last location used by the user, or the most common location used by the user.

At 1107, the system may search for providers that match the criteria set by the user. As discussed above, some embodiments may classify static and non-static criteria and may initially select matching service providers according to static criteria. The non-static criteria may then be compared only to information regarding the limited service providers that matched the static criteria. The searching may involve determining sets of primary and secondary criteria matches where primary matches agree with all of the user's criteria and secondary matches agree with less than all of the criteria. At 1108, the user may be presented with primary results. In some embodiments the primary results may be highlighted as matching all criteria. In other embodiments, the displayed results may be limited to the primary results. At 1109, the user may be presented with secondary results. Depending upon the embodiment, the secondary results may be labeled to reflect that less than all the criteria are met or they may be offered as alternatives to the primary results, as discussed above. Whether results are primary or secondary, in some embodiments of the invention, each resulting service provider may be presented with one or more of the following data items: available times for a booking; distance to the service provider; price for the requested service or offered service; ratings and review information; and indications (e.g., pictures, names, or user names) of persons associated with the end user that have rated or reviewed the service provider (the persons may be associated by a relationship identified on the inventive system or through another system, such as social media services such as FACEBOOK®).

At 1110 a booking or reservation may be accepted from the user and the service provider's scheduling system may be edited to reflect the user's booking and actually reserve the service. At 1111, payment may be accepted from the user through an interface of the client application or through a web interface or by the user's acquiescence to the use of previously submitted payment information. Depending upon the embodiment, the payment may be only a deposit or payment for the full product or service. Note, however, some services (e.g., some car rentals or dinner reservations) may not require any payment until after the service is rendered or the product is delivered. At 1112, the service provider may be paid using the funds paid by the end user or, in some embodiments, using other funds. In one embodiment, any payment or commission due to the proprietor of the inventive system may be withheld from the payment to the provider.

At 1113, rating and review information may be accepted from the end user and/or service provider. In some embodiments, the rating and review information may not be accepted until after the time of the scheduled booking has passed, or rating and review information may only be accepted from users that have a record of purchasing the rated or reviewed service.

Service Providers and Capabilities

Embodiments of the invention may include reference to service provider and service provider components, which represent computing platforms executing software to become machines for performing the desired functions. Businesses contemplated as service providers may include service/product suppliers where personal proximity and scheduling is relevant to the sales, marketing, or distribution of the product. Illustrative service providers include spas, salons, auto-repair businesses, restaurants, hotels, electricians, plumbers, dentists, doctors, lawyers, etc. As discussed above, each service provider or group of service providers may provide access to scheduling and other useful information through a service provider component or a service provider server component.

Sensors on the Client Component

The client component may include sensors, such as GPS hardware, sound (e.g., microphone), motion, cameras, etc. In some embodiments, GPS information may be collected by a GPS chipset hosted on the client component. The GPS information may be used to locate businesses (service providers) in proximity to the client component, and the precise or approximate distance may be reported upon the client user interface as associated with each service provider. The GPS information may also be employed to provide directions to the end user (i.e., user of the client computer) or to offer appropriate related products and services. Similarly, other sensor information may be employed to enhance the user experience or to provide appropriately directed marketing messages. For optimum privacy, some embodiments may seek to use sensor data (as described above) only upon the device where the data is collected. Alternatively, some embodiments may employ the sensor data on other devices, such as a server, where the use of the information may be more efficient, and sensor data from multiple users may be aggregated to provide insight into user behaviors and for additional services. Examples of commercially available software programs that may be included in service provider components are: DEMANDFORCE®; SPABOOKER®; MINDBODY® Online; GOOGLE CALENDAR®; DASHBELL®; GUESTPOINT®; WEBREZPRO®; Frontdesk Anywhere; VAGARO®, SALONBOOKER®; Insight or SALON IRIS®; etc.

In varying embodiments of the invention, service providers may be given a variety of capabilities. In some embodiments, service providers may register with the inventive service optionally through the client services component or a similar component for service provider services. During registration, the service provider may form a profile including static information such as location, type of business, financial interaction information, software interaction information, applicable menus and lists of product and services. Static information may also include rules pertaining to scheduling with the service provider, such as advance notice or cut-off times that are not handled by the service provider's scheduling software. In one or more embodiments, the service provider may make static information available through a computing interface so that the information may be automatically updated. In other embodiments, the static information may be updated through an interface, such as a web-based interface provided by the inventive service and optionally controlled by the client services component or a similar service provider services component. In one embodiment, during the registration process, the service provider may also be required to agree to the inventive system's terms of service, optionally including financial compensation to the proprietor of the inventive system.

Once registered, the service provider may receive appointment information (i.e., bookings) directly into its reservation system. Optionally, some embodiments may include other forms of notification, such as text, fax, or email in addition to, or instead of, interaction with the service provider's reservation system. For example, the inventive system may interact with service providers having no computerized reservation system by using automated texts, emails, or faxes. The registered service provider may also receive payments collected by the inventive service. The payment information and transfer may be automated through interaction with the provider's merchant services system or software (e.g., QUICKBOOKS®, SQUARESPACE™, PAYPAL®, etc.). In some embodiments, the client-user may be charged a transaction fee for various reservations, appointments, or bookings. In other embodiments, the service provider may be charged a fee for receiving bookings through the inventive system. The fee may be time based (e.g., per month), per booking, or a combination of both. In order to make payment more efficient, payments to the service provider may be reduced to reflect the fees owed to the proprietor of the inventive system.

In some embodiments, the service providers may access reports through the client services component or a similar service provider service component. The reports may include information about sales through the inventive system, rating and reviews through the inventive system, financial information such as payment due or received, or other information related to the relationship between the inventive system and the service provider.

The Client Application

As discussed above, the client application may be a cross-platform application in that versions should be available for a variety of different computing platforms, such as iOS, ANDROID®, WINDOWS®, LINUX®, Google GLASS®, MAC OS® (e.g., OSX), etc. The cross platform ability may be achieved through any known or future mechanism available to the skilled artisan.

User Registration/Participation

Users may become associated with the system of various embodiments discussed herein in a variety of ways. For example, in some embodiments, users may register with a server, such as the client services component, through a web-accessible form or by using various social media connections, such as through FACEBOOK® or LINKEDIN®. In any event, many embodiments of the invention may maintain an account for each end user by retaining records in a database upon a server, like the client services component. The account may retain information regarding the user, the user's client component, the user's use of the service, and any other information accessible regarding the user.

Advertising

Some embodiments of the inventive system may use advertising to generate revenue or other value for the proprietor of the system. In one embodiment, service providers may pay an advertising fee for preferred placement or advertising space placement in search results presented to users. In other embodiments, advertising space may be reserved adjacent to results listings and, optionally, the nature of the advertised products and services can be selected to associate with a user's search query or search results (e.g., topically, geographically, or both).

User Interface

Varying embodiments of the invention contemplate a variety of user interfaces. Regarding the client user interface, the client application may accept user input in a variety of ways. Some embodiments may employ a form, for example, where a user employs check boxes, pull-down selection menus, and/or fill-in boxes to describe the businesses desired. For example, if searching for restaurants, the user may specify a desired time, a type of cuisine, a location (e.g., other than the GPS location of the device), a desired ambiance (e.g., outdoor dining available, romantic, family friendly, etc.), or even a specific food type (pizza, steak, etc.). In addition to a form user interface, some embodiments contemplate natural language interpretation where the user simply speaks his or her request in natural language and the criteria are interpreted and parsed from the user's speech.

The following embodiments of user interfaces are intended as illustrative and not restrictive. Furthermore, while the figures show currently envisioned embodiments, each element of the user interface might easily be replaced by a different element having similar functionality. For example, a slider might be replaced with a multi-position button, or a fill-in box might be replaced with a pull-down menu. Moreover, any of the user interface elements may benefit from prior use by the user by, for example, employing history lists for pull-downs or fill-in boxes and behavioral history for default settings on any selectable user interface.

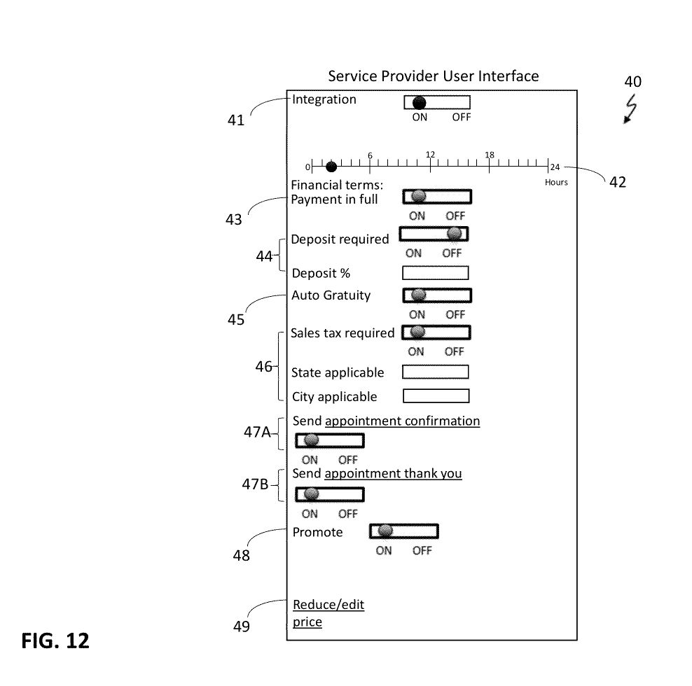

FIG. 12 shows one possible embodiment of a Service Provider User Interface 40. At the top of the user interface, the service provider may use a slider interface to set whether “Integration” 41 is on or off. This allows the Service Provider to terminate or allow access between its applications (such as scheduling applications) and an embodiment of the inventive system by switching it on or off. In addition, the service provider may choose a cut-off time for bookings (as described above) using a timeline interface 42. The service provider may also use sliders to specify various terms, such as: whether payment in full is required at booking 43; whether to require a deposit 44 (if the provider selects yes, an additional interface may appear for entry of the amount or percentage of deposit); whether an automatic gratuity 45, if allowed, should be added to the fee and/or to the payment; whether sales tax 46 should be added to the fee and/or to the payment (in some embodiments, if the provider selects yes, an additional interface may appear for entry of percentage of tax). In addition, the service provider may use fill-in boxes or drop downs 46 to specify the relevant locations of city and state and whether taxes are applicable for those government entities. Moreover, service providers may also use sliders to choose to send appointment confirmations 47A or thank you notes 47B to the client. Service providers may select hyperlinks to draft and edit text to be sent with appointment confirmations 47A and thank you notes 47B. Additionally, service providers may also user sliders to be given the option to promote 48 themselves over the application. Options for promotional opportunities may include, for example, listing prices for services charged or indicating a time period of a sale. The selection of “on” for promotional opportunities may require pop-up agreements and terms. Service providers may also be allowed to edit their listed price on the application 49 or to generally change the terms for purchase of the offered products and series.

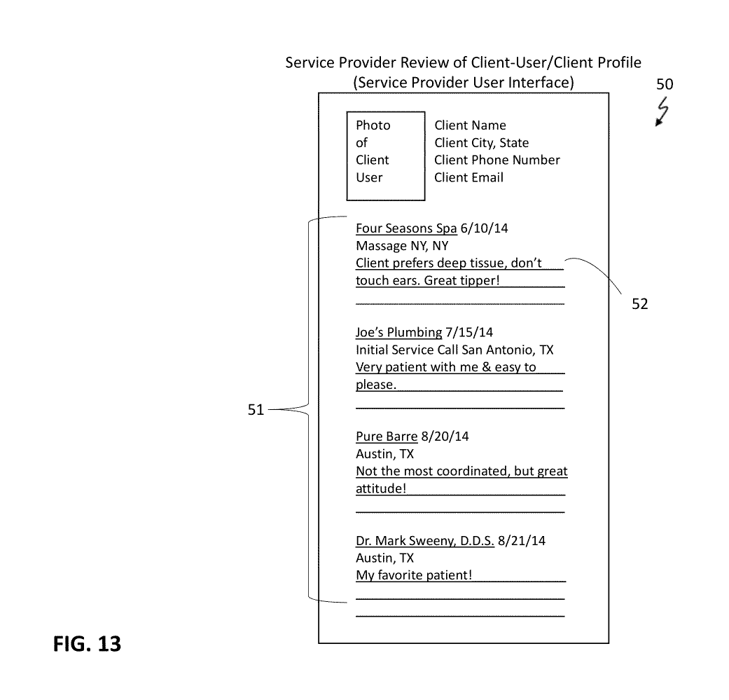

Referring to FIG. 13, there is shown an optional service provider user interface 50 that allows the service provider to review and/or profile the client-user 51. This may be used by the service provider to provide reminders 52 of that particular client's needs and preferences when that client books on the application again. This shows yet another way in which the application may better business dealings between the service provider and the client-user.

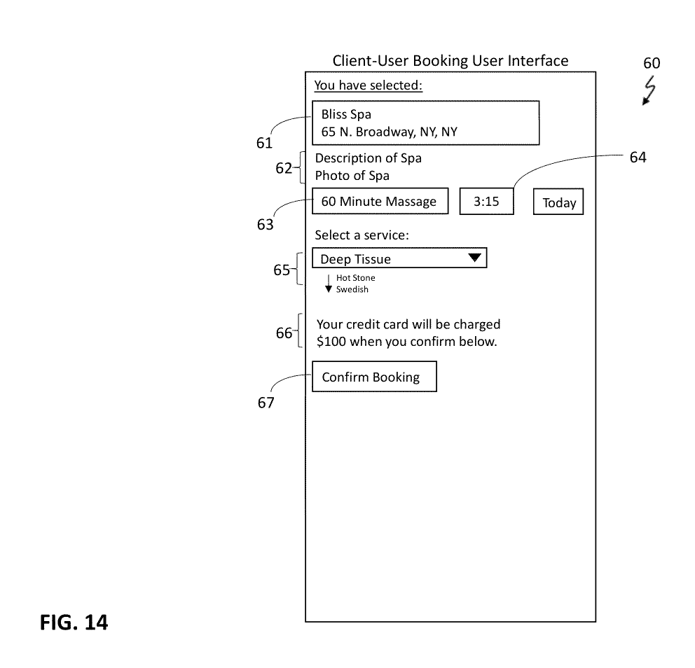

A sample client-user interface used to book appointments 60 is shown by FIG. 14. This interface may be shown to the client after the client has chosen a particular service provider from the client's search results. The interface may use fill-in boxes to list the name of the service provider selected 61. The interface may also provide a photo of the service provider personnel management/ownership and/or a description of the service provider 62. The interface may list what service the client-user is booking 63, as well as the time the client-user is booking 64. Additionally, if the service provider allows it, the client-user may select any additional services offered by the service provider 65. This interface may then provide some indication of the financial terms of the booking, such as identifying the client's credit card being charged for the service 66. Finally, the interface may provide a button interface so the user can confirm the displayed appointment terms 67.

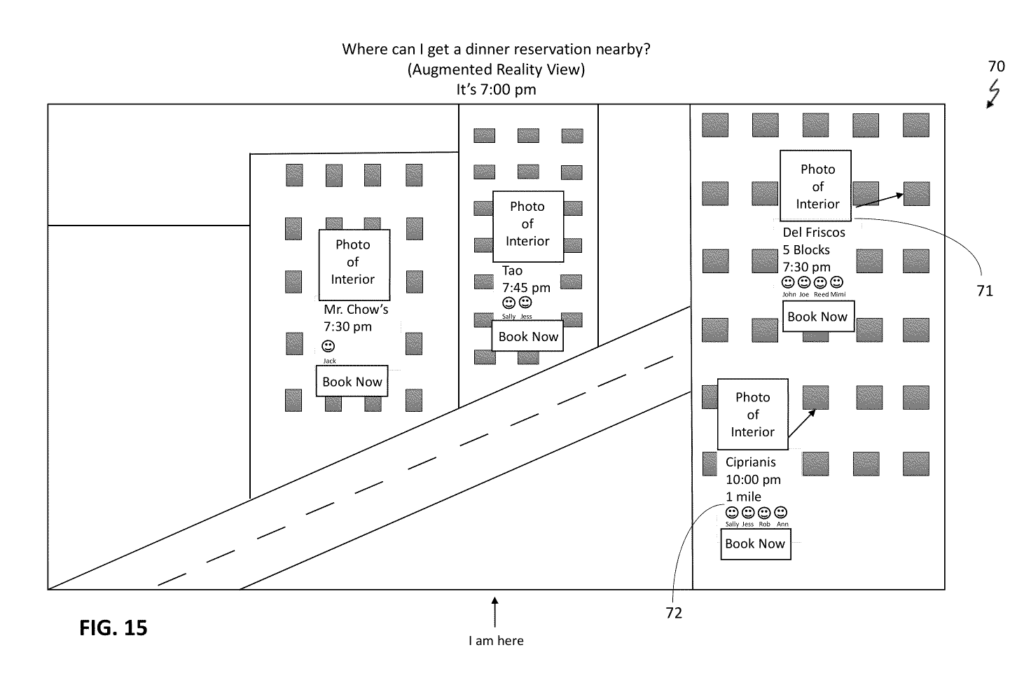

FIG. 15 shows one of many possible client-user interfaces to display results of the client's search. This figure shows the results given to the client-user in augmented reality view 70. Augmented reality allows the user to view the screen of a computing device while a camera in the device captures a live scene wherever the camera is pointed. The device may use GPS, other sensors, and recognition technology (perhaps dynamically acquired over the Internet) to recognize streets, buildings, businesses and many other items in the camera view. Some embodiments of the invention may allow a user to use an augmented reality view to see the goods and services available within their view 71. In these embodiments, the relevant businesses may be identified and available appointment times may be automatically displayed (potentially in a scroll list or using other techniques if there are too many for allowable space). In addition, a client-user may narrow the scope of displayed businesses by setting parameters. For example, the client may search: “Where can I get a dinner reservation nearby?” This will result in the client being able to see all restaurants in the nearby buildings, along with available seating or reservation times 72. The interface may also include the current time.

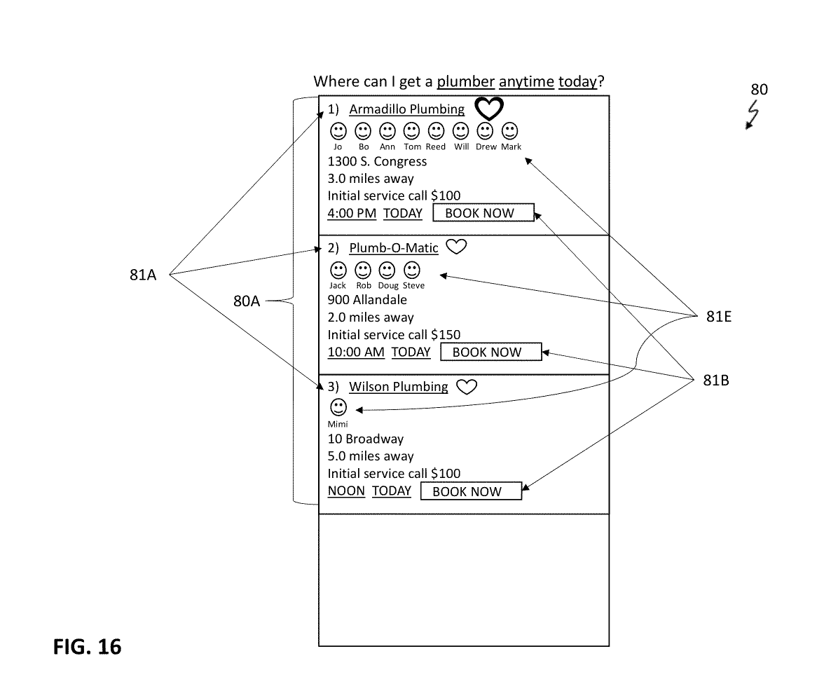

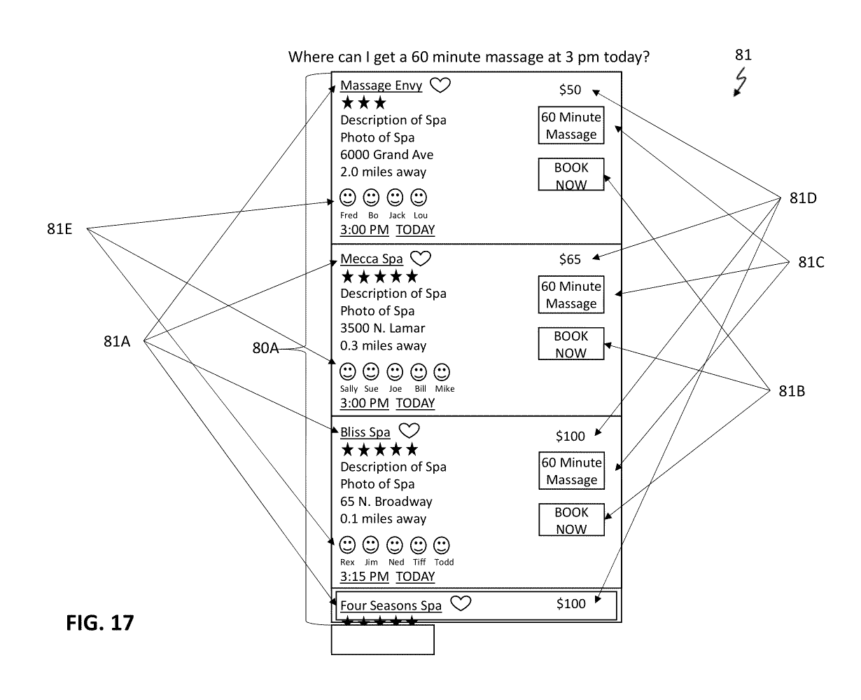

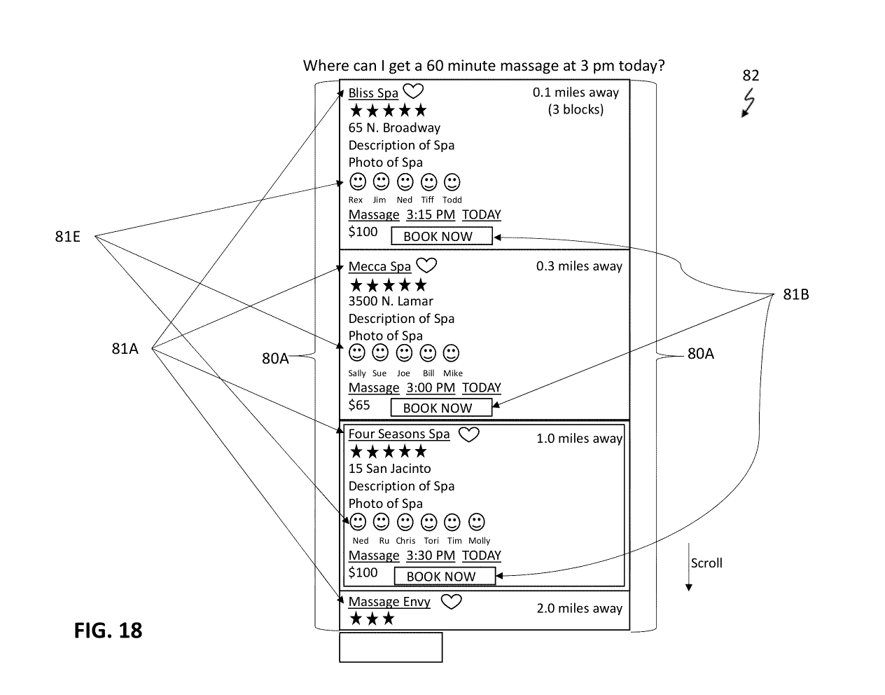

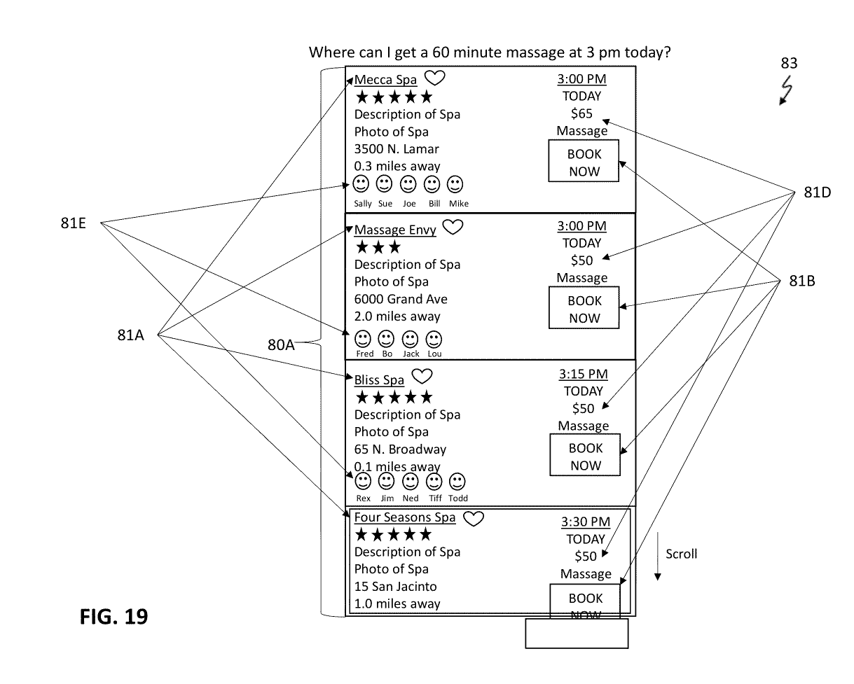

Referring to FIGS. 16-19, there are shown several embodiments for possible client-user interfaces to display search results. FIGS. 16-19 illustrate that the client's results may be shown in list view, and arranged by various factors that are important to the client-user. FIG. 16 illustrates a results page that has been organized by ratings of the service provider 80, FIG. 17 shows a results page that has been arranged by price 81, FIG. 18 displays a results page arranged by distance of the service provider to the desired location or from the user 82, and FIG. 19 shows search results arranged by temporal closeness to the desired time of the appointment 83. The additional information about each service provider given in the list may vary, and may include: the service provider's address; photos, including photos of social connections that have used or rated a service; rating; price; time of available appointments; and distance from desired location and/or client-user 80A. The client-user interface may contain, for example, hyperlinks to service provider profiles 81A, a location of service providers, ratings, a time of an available appointment, links or buttons to place a reservation 81B, links to descriptions of the services provided (e.g., deep tissue or hot stone massage) 81C, prices of the requested service 81D, and photos of social connections who have user the service provider and rated it favorably 81E. Service providers on the list may be highlighted if, for example, the client-user previously used the service provider and rated it favorably.

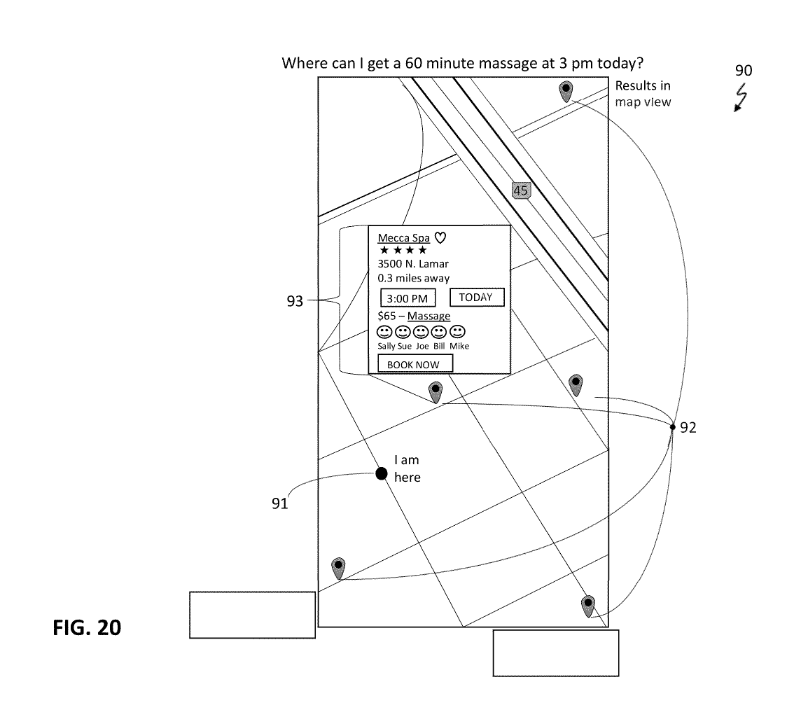

FIG. 20 displays yet another possible client-user interface to display results. FIG. 20 illustrates a map-view of results 90. This results page may show the client-user's current location 91 or desired starting location, and locations of all results 92 (using place markers). The client-user may broaden the search results by having the interface scan out to reveal a larger area. When the client-user clicks on a particular service provider, the details of the service provider may be shown 93. This may include the price of services, available times, distance from the client-user and/or desired location, address, ratings (e.g., client-user ratings), etc.

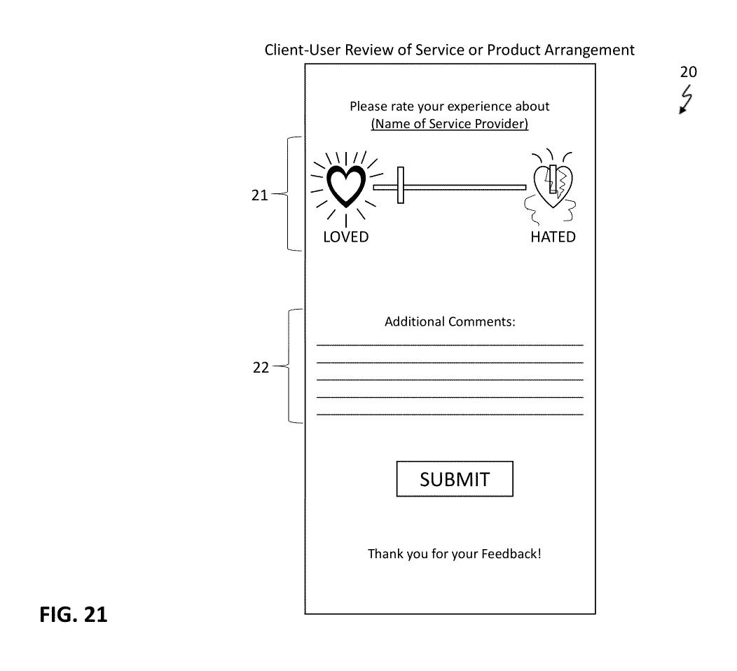

FIG. 21 illustrates a possible client-user interface that would allow the client to rate the service provider 20. This interface may include a sliding scale from a positive rating such as “loved” to a negative rating such as “hated” and use fanciful art work to describe the emotion as shown 21. The client-user may choose a position between these two ratings in order to describe his/her/its satisfaction with the services. Additionally, the client-user may be allowed to write-in additional comments about the services 22. Of course, a review interface may include many other criteria as are commonly known and used in the art.

However the user's input criteria is received, the system may attempt to match the requested criteria and present information regarding service providers that best fit the request. The service providers may be presented in any order or may be ordered by proximity to the user, best fit to the criteria, price, user rating, professional rating, or any ordered or weighted combination of the foregoing. In some embodiments a list of service providers may be presented to the user. Other embodiments may provide a map view and still other embodiments may use an augmented reality interface where the camera is used to present a picture of real world scenery surrounded by text and other information cues to convey information about objects in the scene. Regardless of the mechanism, some embodiments of the invention may offer alternatives choices that meet some, but not all, of the requested criteria. For example, following the restaurant example from above, alternatives may be offered showing: restaurants near the desired location but lacking the desired cuisine; restaurants having reservations available at the desired time and with the desired cuisine, but a little further away from the requested location, etc.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., many of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled.

We claim:

1. A method comprising:
receiving a query upon an interface of a device, the query indicating a desired product or service and an indication of a desired schedule relating to the product or service;
using a camera to capture a live view of a scene;
presenting a sequence of images representing the live view of the scene, the images presented on a display, wherein the display is integrated in the device with the camera and a GPS sensor;
augmenting the images by displaying graphics on the images to identify one or more commercial businesses visible in the images, where the identification of the commercial businesses is responsive to the query and based, at least in part, on an output from the GPS;
for at least one of the identified commercial businesses, displaying one or more scheduling options, including a first scheduling option;
receiving, upon the interface of the device, a selection of the first scheduling option;
sending information reflecting selection of the first scheduling option to a service provider over a network; and
receiving, in response to the information reflecting selection of the first scheduling option, a confirmation of an appointment based upon the first scheduling option.

2. The method of claim 1, wherein the indication of a desired product or service includes a type of business or a type of service.

3. The method of claim 2, wherein the indication of a desired schedule includes a requested time frame.

4. The method of claim 3, wherein the images are further augmented for each of a plurality of the identified commercial businesses, with:
satisfaction information associated with one or more prior customers of the identified commercial business; and
identifying information for a plurality of the one or more prior customers, wherein the plurality of the one or more prior customers are identified as having a social media relationship with a user account represented upon the device.

5. The method of claim 4, wherein the images are further augmented by identifying the social media relationship with each prior user.

6. The method of claim 1, wherein the query includes an indication of distance proximity.

7. The method of claim 1, wherein one or more scheduling options are presented for a plurality of the identified commercial businesses.

8. The method of claim 7, wherein the service provider is associated with an aggregation service that holds scheduling information regarding similar businesses.

9. A computer readable medium comprising one or more instructions that, when executed, configure a processor to:
receive a query upon an interface of a device, the query indicating a desired product or service and an indication of a desired schedule relating to the product or service;
use a camera to capture a live view of a scene,
present a sequence of images representing the live view of the scene, the images presented on a display, wherein the display is integrated in the device with the camera and a GPS sensor;
augment the images by displaying graphics on the images to identify one or more commercial businesses visible in the images, where the identification of the commercial businesses is responsive to the query and based, at least in part, on an output from the GPS;
for at least one of the identified commercial businesses, display one or more scheduling options, including a first scheduling option;
receive, upon the interface of the device, a selection of the first scheduling option;
send, to a service provider over a network, information reflecting selection of the first scheduling option; and
receive, in response to the information reflecting selection of the first scheduling option, a confirmation of an appointment based upon the first scheduling option.

10. The computer readable medium of claim 9, wherein the indication of a desired schedule includes a requested time frame.

11. The computer readable medium of claim 10, wherein the query includes an indication of distance proximity.

12. The computer readable medium of claim 11, wherein one or more scheduling options are presented for a plurality of the identified commercial businesses.

13. The computer readable medium of claim 12, wherein the images are further augmented, for each of a plurality of the identified commercial businesses, with:
satisfaction information associated with one or more prior customers of the identified commercial business; and
identifying information for a plurality of the one or more prior customers, wherein the plurality of the one or more prior customers are identified as having a social media relationship with a user account represented upon the device.

14. The computer readable medium of claim 13, wherein the images are further augmented by identifying the social media relationship with each prior user.

15. The computer readable medium of claim 9, wherein the service provider is associated with an aggregation service that holds scheduling information regarding similar businesses.

16. A system comprising:
one or more CPUs;
one or more cameras for capturing a live view of a scene;
one or more memories for storing program instructions for the one or more CPUs and for storing captured images of the live view of the scene, where the instructions, when executed, cause the one or more CPUs to:
receive a query upon an interface of the system, the query indicating a desired product or service and an indication of a desired schedule relating to the product or service;
use the camera to capture a live view of a scene,
present a sequence of images representing the live view of the scene, the images presented on a display, wherein the display is integrated in the device with the camera and a GPS sensor;
augment the images by displaying graphics on the images to identify one or more commercial businesses visible in the images, where the identification of the commercial businesses is responsive to the query and based, at least in part, on an output from the GPS;
for at least one of the identified commercial businesses, display one or more scheduling options, including a first scheduling option;
receive, upon the interface of the device, a selection of the first scheduling option;
send, to a service provider over a network, information reflecting selection of the first scheduling option; and
receive, in response to the information reflecting selection of the first scheduling option, a confirmation of an appointment based upon the first scheduling option.

17. The system of claim 16, wherein the indication of a desired schedule includes a requested time frame.

18. The system of claim 16, wherein the service provider is associated with an aggregation service that holds scheduling information regarding similar businesses.

19. The system of claim 16, wherein the images are further augmented, for each of a plurality of the identified commercial businesses, with:
satisfaction information associated with one or more prior customers of the identified commercial business; and
identifying information for a plurality of the one or more prior customers, wherein the plurality of the one or more prior customers are identified as having social media relationship with a user account represented upon the device.

20. The system of claim 19, wherein the images are further augmented by identifying the social media relationship with each prior user.
